(19) United States
(12) Patent Application Publication
(10) Pub. No.: US 2024/0015606 A1
(43) Pub. Date: Jan. 11, 2024

(54) METHOD AND APPARATUS FOR HANDOVER

(71) Applicant: LENOVO (BEIJING) LIMITED, BEIJING (CN)

(72) Inventors: XIN GUO, BEIJING (CN); LIANHAI WU, BEIJING (CN); TINGFANG TANG, BEIJING (CN); HAIMING WANG, BEIJING (CN)

(21) Appl. No.: 18/040,840

(22) PCT Filed: Aug. 6, 2020
(86) PCT No.: PCT/CN2020/107507

§ 371 Date: Feb. 7, 2023

(51) Int. Cl. H04W 36/00; H04W 36/30

(52) U.S. Cl. CPC H04W 36/0044; H04W 36/304

(57) ABSTRACT

Embodiments of the present application relate to a method and apparatus for handover in next generation networks (NGNs). An exemplary method includes: a method may include: transmitting information of task associated with a UE; and receiving at least one configuration of task result feedback (TRF) associated with the UE from at least one candidate base station (BS), wherein each configuration indicates how to provide result feedback on the task to the UE via a corresponding candidate BS of the at least one candidate BS. Embodiments of the present application can efficiently guarantee the performance requirements (such as latency, energy, computational capability and so on) of a UE during a handover procedure.

### TECHNICAL FIELD

Embodiments of the present application generally relate to wireless communication technology, especially to a method and apparatus for handover, e.g., in next generation networks (NGNs).

### BACKGROUND

Based on current study items in 3GPP, it is apparently a tendency for the NGN to be integrated with AI technologies. AI is expected as a technology enabler to conduct intelligent management, control and diagnostics for complicated network envisaged by the NGN. On the other hand, AI-based applications are developing quickly to fulfill the ever-increasingly challenging demands of mobile end users, e.g., a user equipment (UE) in the NGN. In the NGN with AI technologies, mobility management for supporting AI-based services in the NGN needs to be carefully studied.

Given the above, the industry desires an improved technology for handover in the NGNs, so as to efficiently guarantee the quality of service (QoS) or quality of experience (QoE) requirements (such as latency, energy, computational capability and so on) of UEs.

### SUMMARY OF THE APPLICATION

Some embodiments of the present application at least provide a technical solution for handover, which can at least be adaptive to the NGNs.

According to some embodiments of the present application, a method may include: transmitting information of task associated with a UE; and receiving at least one configuration of task result feedback (TRF) associated with the UE from at least one candidate base station (BS), wherein each configuration indicates how to provide result feedback on the task to the UE via a corresponding candidate BS of the at least one candidate BS.

According to some other embodiments of the present application, a method may include: receiving information of task associated with UE, wherein the information of task includes an indicator indicating whether any task is in progress for the UE; in response to at least one task being in progress as indicated by the indicator, transmitting a request message for configuration of TRF associated with the UE, wherein the request message includes the information of task.

According to some other embodiments of the present application, a method may include: receiving a request message for configuration of TRF associated with a UE, wherein the request message includes information of task associated with the UE; determining at least one candidate configuration of TRF based on the information of task; and transmitting the at least one candidate configuration of TRF.

Some embodiments of the present application also provide an apparatus, include: at least one non-transitory computer-readable medium having computer executable instructions stored therein, at least one receiver; at least one transmitter; and at least one processor coupled to the at least one non-transitory computer-readable medium, the at least one receiver and the at least one transmitter. The computer executable instructions are programmed to implement any method as stated above with the at least one receiver, the at least one transmitter and the at least one processor.

Embodiments of the present application provide a technical solution for handover, which can efficiently satisfy the QoS or QoE requirements (such as latency, energy, computational capability and so on) of a UE during a handover procedure.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system 100 according to an embodiment of the present application;

FIG. 2 is a flow chart illustrating a method for handover according to some embodiments of the present application;

FIGS. 3(a)-3(c) illustrate examples of information of task according to some embodiments of the present application;

FIGS. 4(a)-4(b) illustrate examples of at least one candidate configuration of TRF according to some embodiments of the present application;

FIG. 5 illustrates a simplified block diagram of an apparatus for handover according to some embodiments of the present application;

FIG. 6 illustrates a simplified block diagram of an apparatus for or handover according to some other embodiments of the present application; and

FIG. 7 illustrates a simplified block diagram of an apparatus for or handover according to some other embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. Persons skilled in the art know very well that, with the development of network architecture and new service scenarios, the embodiments in the present application are also applicable to similar technical problems.

The NGN with AI technologies may need to run a large number of applications and perform large-scale computations. Due to the limited computational capability, storage and battery life of the mobile devices, it is almost impossible for mobile devices to satisfy stringent demands required by AI-based applications, which are characterized by latency-sensitive and compute-intensive. To this end, computation offloading, a computing paradigm, is introduced in the NGN.

A basic design principle of computation offloading is to leverage powerful infrastructures (e.g., remote servers) to augment the computing capability of less powerful devices (e.g., mobile devices). For example, the computation offloading may include edge-oriented computation offloading and cloud-oriented computation offloading. The edge-oriented computation offloading outperforms the cloud-oriented computation offloading in terms of balance between latency and computational capability.

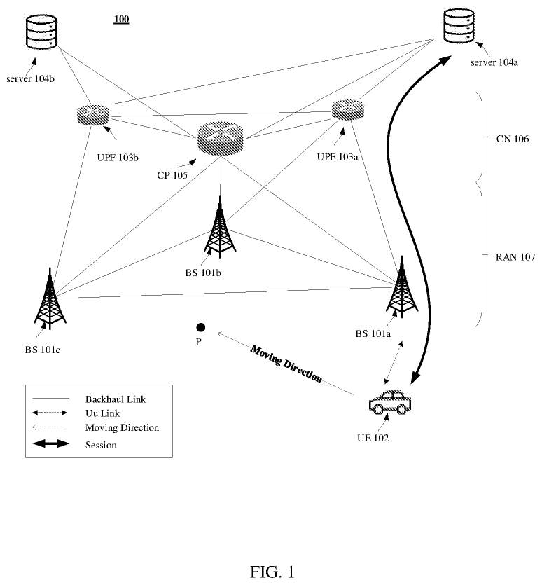

FIG. 1 is a schematic diagram illustrating an exemplary wireless communication system 100 according to an embodiment of the present application.

As shown in FIG. 1, the wireless communication system 100 may include at least one BS (e.g., BS 101a, BS 101b, and BS 101c), at least one UE (e.g. UE 102), at least one user plane function (UPF) (e.g., UPF 103a and UPF 103b), at least one server (e.g., server 104a and server 104b), at least one control plane (e.g. CP 105) and a core network (e.g. CN 106). Radio access network (e.g. RAN 107) may include all BS(s). The core network 106 may include the at least one user plane and control plane.

Although three BSs, one UE, two UPFs and two servers are illustrated in FIG. 1 for simplicity, it is contemplated that the wireless communication system 100 may include more or less BS, UE, UPF, and server in some other embodiments of the present application.

The BS may also be referred to as an access point, an access terminal, a base station, a macro cell, a node-B, an enhanced node B (eNB), a gNB, a home node-B, a relay node, or a device, or described using other terminology used in the art. The BS is generally part of a radio access network that may include a controller communicably coupled to the BS.

UE 102 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, or the like. According to an embodiment of the present application, UE 102 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, UE 102 may include wearable devices, such as smart watches, fitness bands, optical head-mounted displays, or the like. In some embodiments, UE 102 may include vehicles. Moreover, UE 102 may be referred to as a subscriber unit, a mobile, a mobile station, a user, a terminal, a mobile terminal, a wireless terminal, a fixed terminal, a subscriber station, a user terminal, or a device, or described using other terminology used in the art.

The UPF is general responsible for delivery of user data between data network and the UE (via RAN). The server may be an edge node (EN), a content server, a cloud server, or any other server which can run task associated with a UE. The task associated with a UE may be offloaded to the server from the UE or from the network.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

Considering mobility is an inherent characteristic of UEs, how to design efficient mobility management is challenging for supporting task offloading in the context of edge-oriented task offloading, where servers (e.g., ENs) are geo-distributed.

Taking the scenario depicted in FIG. 1 as an example, the UE 102 may be currently served by a source BS (e.g., BS 101a). For a session being in progress for UE 102, at least one task of the session may be offloaded to server 104a via BS 101a and the UPF 103a, as illustrated by bold curve with arrows. UE 102 keeps moving along the direction indicated by the dotted line arrow. When UE 102 moves to the location denoted by P, a handover (HO) decision may be triggered by BS 101a based on measurement reports from UE 102. According to an HO procedure specified in 3GPP, the target BS will be determined by the source BS (e.g., BS 101a) based on the measurement report from UE 102 and handover request acknowledge from at least one candidate BS (e.g., BS 101b and BS 101c).

In the existing HO procedure, service continuity or session continuity has been guaranteed for legacy data access by utilizing a method such as data forwarding. For example, for legacy data access, the data buffered in the source BS will be delivered from the source BS to a determined target BS during the HO execution phase.

However, task offloading differs from the legacy data access in the pattern of resource utilization as well as QoS or QoE requirements, and thus requires distinct information for target BS determination in the HO procedure. For example, for the task offloading, the task may be not required to be delivered during the HO execution phase. Therefore, for different target BS, when and how the task result feedback will be transmitted from the server 104a via the target BS to UE 102 is different.

For example, if BS 101b is determined to be the target BS of UE 102, the task result feedback may be transmitted to UE 102 via a path from server 104a to UPF 103a to BS 101b once the task result is obtained by the server 104a.

If BS 101c is determined to be the target BS of UE 102, the task result feedback may be transmitted to UE 102 via one of two alternative paths once the task result is obtained by server 104a. The first path may be from server 104a to UPF 103a to UPF 103b and then to BS 101c. The second path may be from server 104a to UPF 103a to BS 101c. Alternatively, the task can be transferred to and performed in server 104b (which is closer to BS 101c) and the task results once obtained will be delivered to UE 102 via a path from server 104b to UPF 103b to BS 101c.

Given the above, different determined target BSs in the HO procedure will require different cost to the system when performing task transfer and task result feedback, and thus introduce different QoS or QoE (for example, energy, computational capability and so on) for the task results to be obtained by the end user. Therefore, the determination of target BS in the HO procedure should consider the connection between the server and target BS, thereby satisfying the performance for performing task result feedback to the UE.

Given the above, embodiments of the present application provide a technical solution for handover, which can efficiently guarantee the QoS or QoE requirements (for example, latency, energy, computational capability and so on) of a UE. More details on embodiments of the present application will be illustrated in the following text in combination with the appended drawings.

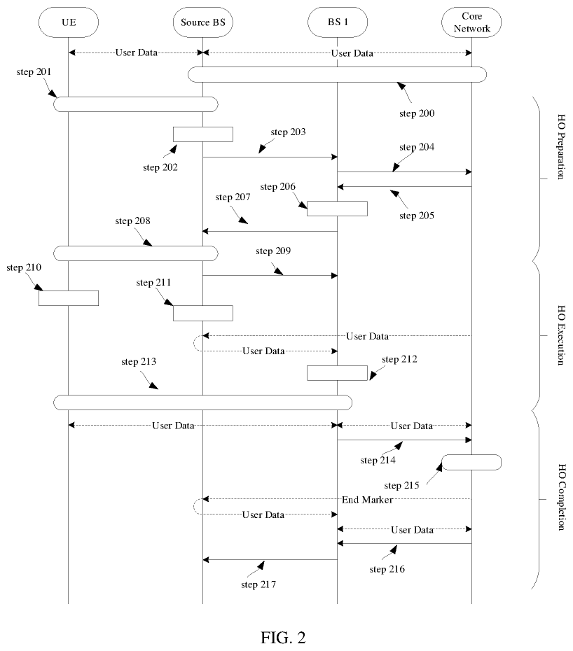

FIG. 2 is a flow chart illustrating a method for handover according to some embodiments of the present application;

Referring to FIG. 2, at step 200, the core network (e.g., the CN 106 as shown in FIG. 1) may provide a context of a UE (e.g., UE 102 as shown in FIG. 1) within a source BS (e.g., BS 101a as shown in FIG. 1) either at a connection establishment phase or at the last tracking area (TA) update phase. The UE context may contain information regarding roaming and access restrictions. The source BS may be a NG-RAN node. In an embodiment of the present application, the NG-RAN node may be an eNB, gNB, ng-eNB, or en-gNB, etc.

At step 201, the source BS may transmit a measurement configuration to the UE, and the UE may report the measurement results according to the measurement configuration. The measurement configuration may include similar information to that specified in 3GPP TS 38.331. For example, the measurement configuration may include measurement objects and measurement reporting configurations.

The measurement objects may include a list of objects on which the UE shall perform the measurements. For intra-frequency and inter-frequency measurements, a measurement object indicates the frequency/time location and subcarrier spacing of reference signals to be measured. For this measurement object, the network may configure a list of cell specific offsets, a list of ‘blacklisted’ cells and a list of ‘whitelisted’ cells. According to some embodiments of the present application, blacklisted cells are not applicable in event evaluation or measurement reporting. Whitelisted cells are the only ones applicable in event evaluation or measurement reporting.

The measurement reporting configurations may include a list of reporting configurations, which may include one or more reporting configurations per a measurement object. Each measurement reporting configuration may include a reporting criterion. The reporting criterion may indicate triggering the UE to send a measurement report periodically or based on an event. For example, the event may be an A3 event or A5 event as specified in 3GPP TS 38.331. The A3 event may refer to that the signal quality of the neighbour cell is better than the signal quality of the severing cell by an offset. The A5 event may refer to that the signal quality of the severing cell becomes worse than a first threshold and the signal quality of the neighbour cell becomes better than a second threshold.

After receiving the measurement configuration, the UE may perform measurement based on the measurement objects and report the measurement results in the case that the reporting criterion is fulfilled.

Step 201 is not essential for the method according to some embodiments of the present application. It is not precluded that the source BS may decide a handover whenever it wishes to at step 202. For example, the source BS may decide to handover the UE based on the measurement results reported from the UE and/or radio resource management information at step 202.

Based on the measurement results reported from the UE, the source BS may determine at least one candidate BS from which a target BS may be selected. In the current technology, the source BS may transmit a handover request to the at least one candidate BS. However, such a handover request does not consider the tasks offloaded to a server.

According to some embodiments of the present application, at step 203, the source BS may transmit information of task associated with the UE to the at least one candidate BS (e.g., BS 1 in FIG. 2). Each of the at least one candidate BS may be a NG-RAN node. For example, the candidate BS may be either the BS 102b or the BS 102c as shown in FIG. 1. Although only one candidate BS (e.g., BS 1) is illustrated in FIG. 2 for simplicity, it is contemplated that the number of candidate BSs may be more than one in some other embodiments of the present application.

According to some embodiments of the present application, the information of task may include an indicator indicating whether any task is in progress associated with the UE. The indicator can be done such as by a field with one bit.

In an embodiment of the present application, in response to at least one task being in progress as indicated by the indicator, the information of task may further include an information unit. The information unit may include at least one task unit.

In some embodiments, each task unit of the at least one task unit includes a server unit. The server unit may include at least an identity (ID) of a server on which a task indicated by the task unit is performed. The ID of a server can be such as an IP address of the server. In some other embodiments, a session may include at least one task. Accordingly, each task unit of the at least one task unit may include a session ID associated with the task. In some other embodiments, each task unit of the at least one task unit may include at least one of QoS or QoE requirement(s) for result feedback of a task to be received by the UE and a residual running time of the task. In some other embodiments, each task unit may include data amount and/or rate of the task result feedback, occupied resources for task running and/or storage (for example, can be expressed in number of virtual machine (VM)), data amount and/or rate of intermediate task result transmission.

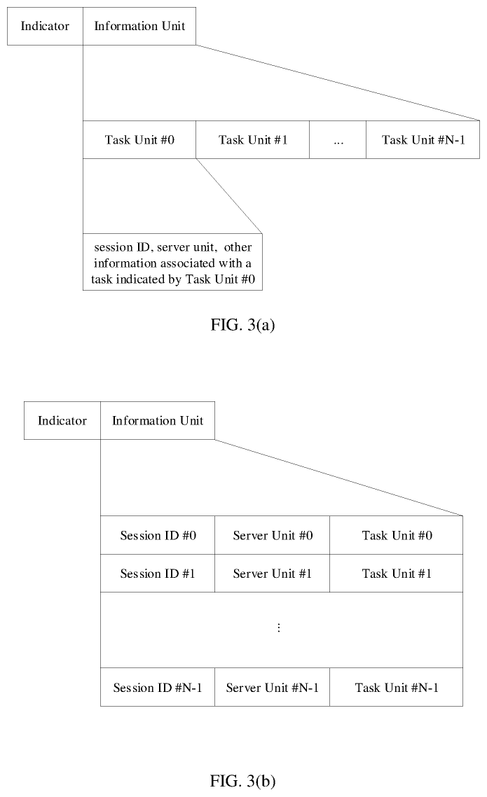

For example, FIG. 3(a) illustrates an example of information of task according to some embodiments of the present application.

Referring to FIG. 3(a), the information of task may include an indicator indicating at least one task is in progress associated with the UE. Therefore, the information of task may include an information unit. The information unit may include N task units labeled as task unit #0, task unit #1, . . . , and task unit #N−1, which means that there are N tasks associated with the UE offloaded to one or more servers, wherein N is a positive integer. These N tasks may come from at least one session.

Each of the task unit may include an ID of a session associated with the task, a server unit indicating the server on which the task is performed, and other information for the task as stated above. For example, task unit #0 may include following information associated with the task indicated by task unit #0: an ID of a session associated with the task, a server unit indicating the server on which the task is performed, and other information (e.g., QoS or QoE requirements for result feedback of the task to be received by the UE and a residual running time of the task) as stated above. Persons skilled in the art can understand that “#0” may not be the ID of the task, while may refer to the index of a task in the sequence of tasks.

In some other embodiments, the session ID and the server unit may be separated from the task unit. For example, FIG. 3(b) illustrates an example of information of task according to some embodiments of the present application.

Referring to FIG. 3(b), the information of task may include an indicator indicating at least one task is in progress associated with the UE. Therefore, the information of task may include an information unit. The information unit may include N entries, which means that there are N tasks associated with the UE offloaded to one or more servers, wherein N is a positive integer. Each entry may be associated with a corresponding task. For example, the first entry may include the following information associated with the task indicated by this entry: session ID #0 indicating a session ID of a session associated with the task, a server unit #0 indicating the server on which the task is performed, and task unit #0 including other information for the task as stated above. Similarly, the second entry may include the session ID #1, a server unit #1, and task unit #1 as stated above. The N-th entry may include a session ID #N−1, a server unit #N−1, and task unit #N−1 as stated above.

In another embodiment of the present application, in response to at least one task being in progress as indicated by the indicator, the information of task may include an information unit. The information unit includes at least one global task ID. Each of the at least one global task ID indicates how to look up a task unit of a task. That is, in this embodiment, the detailed information of the task may be stored in a certain location other than the information unit but associated with the information unit by the global task ID.

In some embodiments, the task unit includes a server unit. The server unit may include at least an ID of a server on which a task indicated by the task unit is performed. In some other embodiments, a session may include at least one task. Accordingly, the task unit may include a session ID associated with the task. In some other embodiments, the task unit may include at least one of QoS or QoE requirements for result feedback of a task to be received by the UE and a residual running time of the task. In some other embodiments, the task unit may include data amount and/or rate of the task result feedback, occupied task running and/or storage resources (for example, can be expressed in number of virtual machine (VM)), data amount and/or rate of intermediate task result transmission.

In some embodiments, each global task ID may include an ID of a storage node in which the task unit is stored, an ID of the UE associated with the task, and an ID of a session associated with the task.

For example, FIG. 3(c) illustrates an example of information of task according to some embodiments of the present application.

Referring to FIG. 3(c), the information of task may include an indicator indicating at least one task is in progress associated with the UE. Therefore, the information of task may include an information unit. The information unit may include N global task IDs labeled as global task ID #0, global task ID #1, . . . , and global task ID #N−1, which means that there are N tasks associated with the UE offloaded to one or more servers, wherein N is a positive integer. Each global task ID may indicate how to look up a task unit of a task.

For example, global task ID #0 may include the following information associated with the task indicated by task unit #0: an ID of a storage node in which task unit #0 is stored, an ID of the UE associated with the task, and an ID of a session associated with the task. Task unit #0 may include the following information associated with the indicated by task unit #0, for example, the server ID associated with the task, the session ID of the task, and other information (e.g., QoS or QoE requirements for result feedback of the task to be received by the UE and a residual running time of the task) as stated above. Persons skilled in the art can understand that ‘#0’ may not be the ID of the task, while may refer to the index of a task in the sequence of tasks.

In yet another embodiment of the present application, in response to no task being in progress as indicated by the indicator, the information unit may be null.

According to some embodiments of the present application, the information of task may be included in a message, for example, in an HO request message.

After receiving the information of task, each candidate BS may check the indicator in the information of task. In response to no task being in progress as indicated by the indicator, the candidate BS may perform the normal admission control as specified in 3GPP 38.300.

In response to at least one task being in progress as indicated by the indicator, at step 204, each candidate BS may transmit a request message for configuration of TRF associated with the UE to the core network. The request message may include the information of task.

After receiving the request message for configuration of TRF from each candidate BS, the core network may determine at least one candidate configuration of TRF based on the information of task for each candidate BS. Then, at step 205, the core network may transmit at least one candidate configuration of TRF to each candidate BS. Each candidate configuration may indicate how to provide result feedback on the task to the UE via a corresponding candidate BS of the at least one candidate BS.

For example, assuming that a candidate BS (e.g., BS 1) may represent either BS 101b or BS 101c shown in FIG. 1, after receiving the information of task from the source BS (e.g., BS 101a), BS 1 may transmit a request message for candidate configuration of TRF to the core network. In the case that BS 1 represents BS 101b, since there is only one path (server 104a to UPF 103a to BS 101b) to deliver the task result from server 104a to the UE 102 via the BS 101b, the core network may transmit one candidate configuration of TRF to BS 1 indicating the above one path.

In the case that BS1 represents BS 101c, there may be three paths to deliver the task result from server 104a to the UE 102 via BS 101c. For example, a first path is from server 104a to UPF 103a to UPF 103b to BS 101c. A second path is from server 104a to UPF 103b to BS 102c. A third path may include firstly transferring the task performed in server 104a as an intermediate task result to server 104b and secondly delivering task result obtained in server 104b to UPF 103b to BS 101c. The core network may transmit three candidate configurations of the TRY to BS 1, indicating the above three paths respectively.

According to some embodiments of the present application, each candidate configuration of the at least one candidate configuration of TRF includes at least one TRF unit.

According to some other embodiments of the present application, each candidate configuration may have a corresponding configuration ID, and the configuration ID may be included in the at least one TRF unit of the candidate configuration or may be separated from the at least one TRF unit.

According to an embodiment of the present application, each TRF unit of the at least one TRF unit includes an ID of a session associated with a task indicated by the TRF unit. In an embodiment, each TRY unit of the at least on TRY unit includes a server unit. In some embodiments, the server unit includes at least one of an ID (e.g., IP address) of a server on which a task indicated by the TRY unit is performed and routing information between the server and the candidate BS. In an embodiment, the routing information may include at least end-to-end latency of a routing path between the server and the candidate BS. In another embodiment, the routing information may include information of the routing path. In another embodiment, the routing information may include information of nodes included in the routing path.

According to another embodiment of the present application, each TRF unit may include time when result feedback of task will be transmitted back from a server and a configuration for transmitting the result feedback along the routing path between the server and the candidate BS.

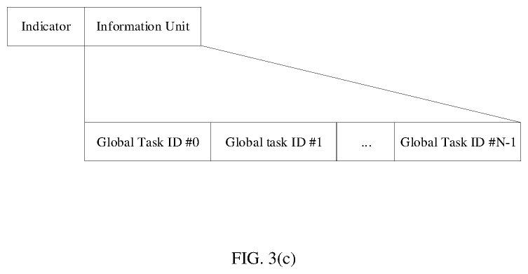

For example, FIG. 4(a) illustrates an example of at least one candidate configuration of TRF according to some embodiments of the present application.

Referring to FIG. 4(a), the at least one candidate configuration of TRF may include N candidate configurations of TRF, wherein N is a positive integer. Taking a candidate configuration labeled by #N−1 as an example, it may include a configuration ID #N−1 indicating the candidate configuration and M_{N-1} TRF units labeled as TRF unit #0, TRF unit #1, . . . , TRF unit #M_{N-1}. The number M_{N-1} is a positive integer, which represents the number of different tasks involved in the candidate configuration labeled as Configuration ID #N−1.

Each TRF unit may include an ID of a session associated with a task indicated by the TRF unit. Each TRF unit may include a server unit. The server unit includes at least one of an ID (e.g., an IP address) of a server on which a task indicated by the TRF unit is performed and routing information between the server and the candidate BS.

For example, TRF unit #0 may include session ID #0 and server unit #0. Server unit #0 may include an ID (e.g., an IP address) of a server on which a task indicated by TRF unit #0 is performed and routing information between the server and the candidate BS. Similarly, TRF unit #1 may include session ID #1 and server unit #1. Server unit #1 may include an ID (e.g., IP address) of a server on which a task indicated by TRF unit #1 is performed and routing information between the server and the candidate BS. TRF unit #M_{N-1} may include a session ID #M_{N-1} and a server unit #M_{N-1}. Server unit #M_{N-1} may include an ID (e.g., an IP address) of a server on which a task indicated by TRF unit #M_{N-1} is performed and routing information between the server and the candidate BS.

Each TRF unit may also include time when result feedback of task will be transmitted back from a server and configuration for transmitting the result feedback. For example, TRF unit #0 may include time when result feedback of task will be transmitted back from server indicated by server unit #0 and configuration for transmitting the result feedback, TRF unit #1 may include time when result feedback of task will be transmitted back from server indicated by server unit #1 and configuration for transmitting the result feedback, TRF unit #M_{N-1} may include time when result feedback of task will be transmitted back from server indicated by server unit #M_{N-1} and configuration for transmitting the result feedback.

In some embodiments, the server unit may be separated from the TRF unit. For example, FIG. 4(b) illustrates an example of a candidate configuration of TRF according to some embodiments of the present application.

Referring to FIG. 4(b), the difference between FIG. 4(b) and FIG. 4(a) is that the server unit in FIG. 4(b) is separated from its corresponding TRF unit. In this example, the information included in the server unit is the same as that in FIG. 4(a), the TRF unit may include remaining information except for the server unit in FIG. 4(a).

After receiving the at least one candidate configuration, at step 206, each candidate BS (e.g., BS 1) may perform admission control.

Among others operations as specified in 3GPP TS 38.300, the candidate BS may perform admission control based on the at least one candidate configuration of TRF to select a configuration of TRF from the at least one candidate configuration of TRF which can fulfill a handover requirement of the UE. That is, the HO request from the UE can be accepted.

After that, at step 207, each candidate BS (e.g., BS 1) may transmit the selected configuration of TRF to the source BS.

According to some embodiments of the present application, the selected configuration of TRF may be included in a second message, for example, a HO request acknowledge message. In these embodiments, each candidate BS may prepare the handover with layer 1 (L1)/layer 2 (L2) and send the HO request acknowledge to the source BS. The HO request acknowledge message may include a RRC reconfiguration message to be delivered to the UE to perform the handover via the source BS. The selected configuration of TRF can be contained as partial information in the HO request acknowledge message.

After receiving the at least one selected configuration of TRF from at least one candidate BS, respectively, at step 208, the source BS may determine a target BS from the at least one candidate BS based on the at least one selected configuration of TRF. In the example of FIG. 2, the source BS may determine BS 1 representing BS 101b in FIG. 1 as the target BS to handover for the UE.

At step 208, the source BS may transmit the RRC reconfiguration message contained in the HO request acknowledge from the target BS to the UE to indicate the UE to perform a handover procedure with the target BS. According to some embodiments of the present application, the RRC reconfiguration message may include information required to access the target cell, i.e., at least the target cell ID, the new cell-radio network temporary identifier (C-RNTI), the target BS security algorithm identifiers for the selected security algorithms and system information of the target cell, etc.

At step 209, the source BS may transmit a secondary node (SN) status transfer message to the target BS.

After receiving the RRC reconfiguration message, at step 210, the UE detaches from the source BS and synchronizes to the target BS.

At step 211, downlink data destined for the UE is still provided from the core network to the source BS, which forwards the data to the target BS. At step 212, the target BS buffers the data forwarded from the source BS and waits for the UE to finalize the handover.

At step 213, the UE may synchronize to the target cell and completes the RRC handover procedure by sending a RRC reconfiguration complete message to target BS. In the case of dual active protocol stack (DAPS) HO, the UE does not detach from the source cell upon receiving the RRC reconfiguration message. The UE may release the source signaling radio bearer (SRB) resources, security configuration of the source cell and stops downlink reception/uplink transmission with the source BS after receiving an explicit release from the target BS.

At step 214, the target BS (e.g., BS 1) may transmit a path switch request message to the core network. The path switch request message may include the selected configuration of TRF.

The target BS transmits the path switch request message to the core network to trigger the core network to switch the DL data path towards the target BS and to establish an NG-C interface instance towards the target BS.

After receiving the path switch request, at step 215, the core network may perform a path switch based on the selected configuration of TRF. According to some embodiments of the present application, the core network will perform reconfiguration of the task according to the information included in the selected configuration of TRF. According to some other embodiments of the present application, the core network may switch the DL data path towards the target BS. The core network may send one or more “end marker” packets on the old path to the source BS per PDU session/tunnel and then can release any U-plane/transport network layer (TNL) resources towards the source BS.

At step 216, as a confirmation of the path switch request message, the core network may transmit a path switch request acknowledge message to the target BS.

In response to the reception of the path switch request acknowledge message from the core network, the target BS may send the UE context release to inform the source BS about the success of the handover at step 217. The source BS can then release radio and control plane (C-plane) related resources associated to the UE context. After that, any ongoing data forwarding may continue.

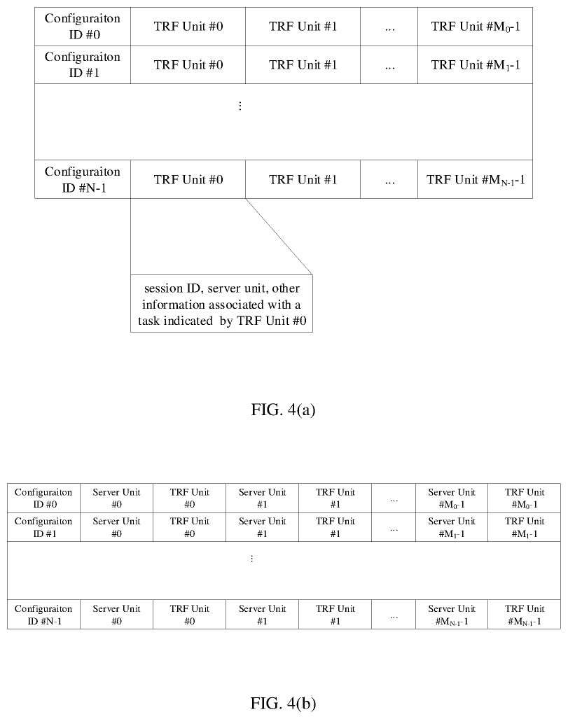

FIG. 5 illustrates a simplified block diagram of an apparatus for handover according to some embodiments of the present application. The apparatus 1100 may be a source BS (for example, BS 101a) as shown in FIG. 1.

Referring to FIG. 5, the apparatus 500 may include at least one non-transitory computer-readable medium 502, at least one receiving circuitry 504, at least one transmitting circuitry 506, and at least one processor 508. In some embodiment of the present application, at least one receiving circuitry 504 and at least one transmitting circuitry 506 and be integrated into at least one transceiver. The at least one non-transitory computer-readable medium 502 may have computer executable instructions stored therein. The at least one processor 508 may be coupled to the at least one non-transitory computer-readable medium 502, the at least one receiving circuitry 504 and the at least one transmitting circuitry 506. The computer executable instructions can be programmed to implement a method with the at least one receiving circuitry 504, the at least one transmitting circuitry 506 and the at least one processor 508. The method can be a method according to an embodiment of the present application, for example, the method shown in FIG. 2.

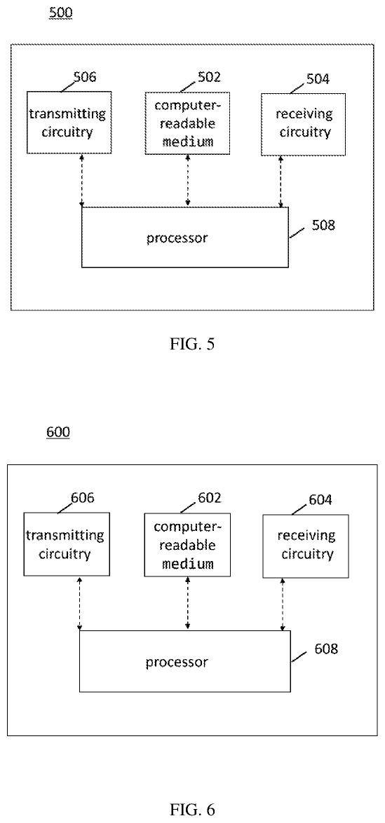

FIG. 6 illustrates a simplified block diagram of an apparatus for handover according to some other embodiments of the present application. The apparatus 600 may be a candidate BS (for example, the BS 101b and 101c as show in FIG. 1).

Referring to FIG. 6, the apparatus 600 may include at least one non-transitory computer-readable medium 602, at least one receiving circuitry 604, at least one transmitting circuitry 606, and at least one processor 608. In some embodiment of the present application, at least one receiving circuitry 604 and at least one transmitting circuitry 606 and be integrated into at least one transceiver. The at least one non-transitory computer-readable medium 602 may have computer executable instructions stored therein. The at least one processor 608 may be coupled to the at least one non-transitory computer-readable medium 602, the at least one receiving circuitry 604 and the at least one transmitting circuitry 606. The computer executable instructions can be programmed to implement a method with the at least one receiving circuitry 604, the at least one transmitting circuitry 606 and the at least one processor 608. The method can be a method according to an embodiment of the present application, for example, the method shown in FIG. 2.

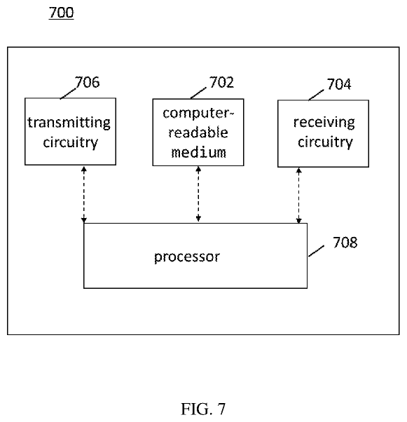

FIG. 7 illustrates a simplified block diagram of an apparatus for handover according to some other embodiments of the present application. The apparatus 600 may be a core network (for example, the core network 106 as show in FIG. 1).

Referring to FIG. 7, the apparatus 700 may include at least one non-transitory computer-readable medium 702, at least one receiving circuitry 704, at least one transmitting circuitry 706, and at least one processor 708. In some embodiment of the present application, at least one receiving circuitry 704 and at least one transmitting circuitry 706 and be integrated into at least one transceiver. The at least one non-transitory computer-readable medium 702 may have computer executable instructions stored therein. The at least one processor 708 may be coupled to the at least one non-transitory computer-readable medium 702, the at least one receiving circuitry 704 and the at least one transmitting circuitry 706. The computer executable instructions can be programmed to implement a method with the at least one receiving circuitry 704, the at least one transmitting circuitry 706 and the at least one processor 708. The method can be a method according to an embodiment of the present application, for example, the method shown in FIG. 2.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for emotion recognition from speech, including a processor and a memory. Computer programmable instructions for implementing a method for emotion recognition from speech are stored in the memory, and the processor is configured to perform the computer programmable instructions to implement the method for emotion recognition from speech. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for emotion recognition from speech as stated above or other method according to an embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1.-11. (canceled)

12.-28. (canceled)

29.-42. (canceled)

43. An apparatus comprising:
at least one non-transitory computer-readable medium having computer executable instructions stored therein;
at least one receiver;
at least one transmitter; and
at least one processor coupled to the at least one non-transitory computer-readable medium, the at least one receiver and the at least one transmitter;
wherein the computer executable instructions cause the at least one processor to:
transmit information of task associated with a user equipment (UE); and
receive at least one configuration of task result feedback (TRF) associated with the UE from at least one candidate base station (BS), wherein each configuration indicates how to provide result feedback on at least one task to the UE via a corresponding candidate BS of the at least one candidate BS.

44.-45. (canceled)

46. The apparatus of claim 43, wherein the information of the task includes an indicator indicating whether any task is in progress for the UE.

47. The apparatus of claim 46, wherein in response to at least one task being in progress as indicated by the indicator, the information of task further includes an information unit, wherein the information unit includes at least one task unit.

48. The apparatus of claim 47, wherein:
each task unit of the at least one task unit includes a server unit, the server unit including at least an identity (ID) of a server; and
each task unit of the at least one task unit includes at least one of quality of service (QoS) or quality of experience (QoE) requirement(s) for result feedback of a task to be received by the UE and a residual running time of the task.

49. The apparatus of claim 46, wherein in response to at least one task being in progress as indicated by the indicator, the information of task further includes an information unit, wherein the information unit includes at least one global task ID, wherein each of the at least one global task ID indicates how to look up a task unit of a task, wherein each global task ID includes an ID of a storage node in which the task unit is stored, an ID of the UE associated with the task, and an ID of a session associated with the task.

50. The apparatus of claim 43, wherein the information of task is included in a handover (HO) request message and each configuration of the at least one configuration of TRF is received in a HO request acknowledge from the corresponding candidate BS.

51. The apparatus of claim 43, wherein the computer executable instructions cause the at least one processor to:
determine a target BS from the at least one candidate BS based on the at least one configuration of TRF; and
transmit a radio resource control (RRC) reconfiguration message to the UE to indicate to the UE to perform a handover procedure with the target BS.

52. An apparatus comprising:
at least one non-transitory computer-readable medium having computer executable instructions stored therein;
at least one receiver;
at least one transmitter; and
at least one processor coupled to the at least one non-transitory computer-readable medium, the at least one receiver and the at least one transmitter;
wherein the computer executable instructions cause the at least one processor to:
receive information of task associated with a user equipment (UE), wherein the information of task includes an indicator indicating whether any task is in progress for the UE; and
in response to at least one task being in progress as indicated by the indicator, transmit a request message for configuration of task result feedback (TRF) associated with the UE, wherein the request message includes the information of task.

53. The apparatus of claim 52, wherein the computer executable instructions cause the at least one processor to:
receive at least one candidate configuration of TRF associated with the UE;
wherein each configuration of the at least one candidate configuration of TRF includes at least one TRF unit, wherein each TRF unit of the at least one TRF unit includes a server unit, and wherein the server unit includes at least one of an ID of a server and routing information between the server and the candidate BS.

54. The apparatus of claim 53, wherein each TRF unit includes time when result feedback of task will be transmitted back from a server and a configuration for transmitting the result feedback along a routing path between the server and the candidate BS.

55. The apparatus of claim 52, wherein in response to at least one task being in progress as indicated by the indicator, the information of task further includes an information unit, wherein the information unit includes at least one task unit, wherein each task unit of the at least one task unit includes a server unit, wherein the server unit includes at least an identity (ID) of a server, and wherein each task unit of the at least one task unit includes at least one of quality of service (QoS) or quality of experience (QoE) requirement(s) for result feedback of a task to be received by the UE and a residual running time of the task.

56. The apparatus of claim 52, wherein in response to at least one task being in progress as indicated by the indicator, the information of task further includes an information unit, wherein the information unit includes at least one global task ID, wherein each of the at least one global task ID indicates how to look up a task unit of a task, wherein each global task ID includes an ID of a storage node in which the task unit is stored, an ID of the UE associated with the task, and an ID of a session associated with the task.

57. The apparatus of claim 52, wherein:
the information of task is included in a handover (HO) request message; and
the computer executable instructions cause the at least one processor to:
receive at least one candidate configuration of TRF associated with the UE;
perform admission control based on the at least one candidate configuration of TRF to select a configuration of TRF from the at least one candidate configuration of TRF which can fulfill a handover requirement; and
transmit the selected configuration of TRF in a HO request acknowledge.

58. An apparatus comprising:
at least one non-transitory computer-readable medium having computer executable instructions stored therein;
at least one receiver;
at least one transmitter; and
at least one processor coupled to the at least one non-transitory computer-readable medium, the at least one receiver and the at least one transmitter;
wherein the computer executable instructions are programmed to cause the at least one processor to:
receiving a request message for configuration of task result feedback (TRF) associated with a user equipment (UE), wherein the request message includes information of task associated with the UE;
determine at least one candidate configuration of TRF based on the information of task; and
transmit the at least one candidate configuration of TRF.

59. The apparatus of claim 58, wherein the information of task includes an indicator indicating whether any task is in progress for the UE.

60. The apparatus of claim 59, wherein in response to at least one task being in progress as indicated by the indicator, the information of task further includes an information unit, wherein the information unit includes at least one task unit, wherein each task unit of the at least one task unit includes a server unit, wherein the server unit includes at least an identity (ID) of a server.

61. The apparatus of claim 59, wherein in response to at least one task being in progress as indicated by the indicator, the information of task further includes an information unit, wherein the information unit includes at least one global task ID, wherein each of the at least one global task ID indicates how to look up a task unit of a task, wherein each global task ID includes an ID of a storage node in which the task unit is stored, an ID of the UE associated with the task, and an ID of a session associated with the task.

62. The apparatus of claim 58, wherein each of the at least one candidate configuration of TRF includes at least one TRF unit, wherein each TRF unit of the at least one TRF unit includes a server unit, wherein the server unit includes at least one of an ID of a server and routing information between the server and the candidate BS.

63. The apparatus of claim 62, wherein each of the at least one TRF unit includes time when result feedback of task will be transmitted back from a server and a configuration for transmitting the result feedback along a routing path between the server and the candidate BS.

64. The apparatus of claim 58, wherein the computer executable instructions cause the at least one processor to:
receive a path switch request message, wherein the path switch request message includes a selected configuration of TRF of the at least one candidate configuration of TRF; and
perform a path switch based on the selected configuration of TRF.
